(19) United States
(12) Patent Application Publication
(10) Pub. No.: US 2026/0134694 A1
(43) Pub. Date: May 14, 2026

(54) OPTIMIZING ARTIFICIAL INTELLIGENCE MODEL UNDERSTANDING OF COMPLEX TRAFFIC INTERACTIONS

(71) Applicant: NEC Laboratories America, Inc., Princeton, NJ (US)

(72) Inventors: Francesco Pittaluga, Los Angeles, CA (US); Wei-Jer Chang, Fremont, CA (US)

(21) Appl. No.: 19/386,892

(22) Filed: Nov. 12, 2025

Related U.S. Application Data
(60) Provisional application No. 63/719,717, filed on Nov. 13, 2024.

(51) Int. Cl. G06V 20/54; B60W 60/00; G06V 20/70; G06V 40/20

(52) U.S. Cl. CPC G06V 20/54; B60W 60/001; G06V 20/70; G06V 40/20

(57) ABSTRACT

Systems and methods for optimizing artificial intelligence model understanding of complex traffic interactions. Identifying agents can be identified from input videos based on agent heuristics. Interaction behaviors between the agents can be determined based on interaction heuristics. An integrated dataset can be autonomously generated based on the agents and the interaction behaviors that enhances performance of an artificial intelligence (AI) model to adapt to various scene attributes. Semantic understanding of the AI model can be optimized based on the generated dataset by updating hidden states of the AI model through training.

### RELATED APPLICATION INFORMATION

This application claims priority to U.S Provisional App. No. 63/719,717, filed on November 13, 2024, incorporated herein by reference in its entirety.

### BACKGROUND

### Technical Field

The present invention relates to optimizing artificial intelligence (AI) models, and more particularly optimizing artificial intelligence model understanding of complex traffic interactions.

### Description of the Related Art

AI models have been widely used in natural language processing, image processing, and generating inferences. However, the accuracy of these AI models are linked to how they are trained, the quality of training data, and the methods used for training. It follows that quality training data would produce a more accurate AI model.

### SUMMARY

According to an aspect of the present invention, a method is provided, including, identifying agents from input videos based on agent heuristics, determining interaction behaviors between the agents based on interaction heuristics, autonomously generating an integrated dataset based on the agents and the interaction behaviors that enhances performance of an artificial intelligence (AI) model to adapt to various scene attributes, and optimizing semantic understanding of the AI model based on the generated dataset by updating hidden states of the AI model through training.

According to another aspect of the present invention, a system is provided, including, a memory device, and one or more processor devices operatively coupled with the memory device to perform operations including, identifying agents from input videos based on agent heuristics, determining interaction behaviors between the agents based on interaction heuristics, autonomously generating an integrated dataset based on the agents and the interaction behaviors that enhances performance of an artificial intelligence (AI) model to adapt to various scene attributes, and optimizing semantic understanding of the AI model based on the generated dataset by updating hidden states of the AI model through training.

According to yet another aspect of the present invention, A non-transitory computer program product including a computer-readable storage medium including a program code is provided, wherein the program code when executed on a computer causes the computer to perform operations including, identifying agents from input videos based on agent heuristics, determining interaction behaviors between the agents based on interaction heuristics, autonomously generating an integrated dataset based on the agents and the interaction behaviors that enhances performance of an artificial intelligence (AI) model to adapt to various scene attributes, and optimizing semantic understanding of the AI model based on the generated dataset by updating hidden states of the AI model through training.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram that shows a system for optimizing artificial intelligence model understanding of complex traffic interactions, in accordance with an embodiment of the present invention;

FIG. 2 is a block diagram that shows a computer system for optimizing artificial intelligence model understanding of complex traffic interactions, in accordance with an embodiment of the present invention;

FIG. 3 is a block diagram that shows hardware and software components of a computer system for optimizing artificial intelligence model understanding of complex traffic interactions, in accordance with an embodiment of the present invention;

FIG. 4 is a block diagram that shows a neural network for optimizing artificial intelligence model understanding of complex traffic interactions, in accordance with an embodiment of the present invention;

FIG. 5 is a flow diagram that shows a high-level overview of optimizing artificial intelligence model understanding of complex traffic interactions, in accordance with an embodiment of the present invention; and

FIG. 6 is a block diagram showing a practical application of optimizing artificial intelligence model understanding of complex traffic interactions, in accordance with an embodiment of the present invention.

### DETAILED DESCRIPTION OF PREFERRED EMBODIMENTS

In accordance with embodiments of the present invention, systems and methods are provided for optimizing artificial intelligence model understanding of complex traffic interactions.

In the present embodiments, agents can be identified from input videos based on agent heuristics. Interaction behaviors between the agents can be determined based on interaction heuristics. An integrated dataset can be autonomously generated based on the agents and the interaction behaviors that enhances performance of an artificial intelligence (AI) model to adapt to various scene attributes. Semantic understanding of the AI model can be optimized based on the generated dataset by updating hidden states of the AI model through training.

In real-world scenarios, traffic involves a myriad of nuanced interactions between agents—such as vehicles, pedestrians, and other road users—that autonomous systems must understand and respond to safely and effectively. Traditional datasets for autonomous driving often fall short in their coverage of diverse and subtle interaction types, particularly in their lack of detailed annotations for complex behaviors and context-specific interactions. The present embodiments generate an integrated dataset that aims to fill this gap by providing high-quality, human-annotated labels for intricate agent-agent interactions within well-known real-world datasets.

The integrated dataset optimizes simulating, predicting, and understanding these interactions to improve decision-making in autonomous vehicles. By annotating interactions across two prominent datasets (e.g., Waymo and NuPlan) with both interaction-specific labels and heuristic single-agent behavioral annotations, the integrated dataset provides a comprehensive foundation for modeling how agents interact in a variety of traffic situations. The integrated dataset includes detailed categorizations for interaction types, such as lane-changing, yielding, merging, and overtaking, allowing for precise, context-driven predictions and responses from autonomous systems.

The present embodiments optimize AI model understanding of complex traffic interactions by utilizing a structured, high-resolution view of traffic interactions that supports the development of trajectory simulation models capable of capturing the subtle dynamics of real-world traffic, advancing the safety and reliability of autonomous vehicle decision-making.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

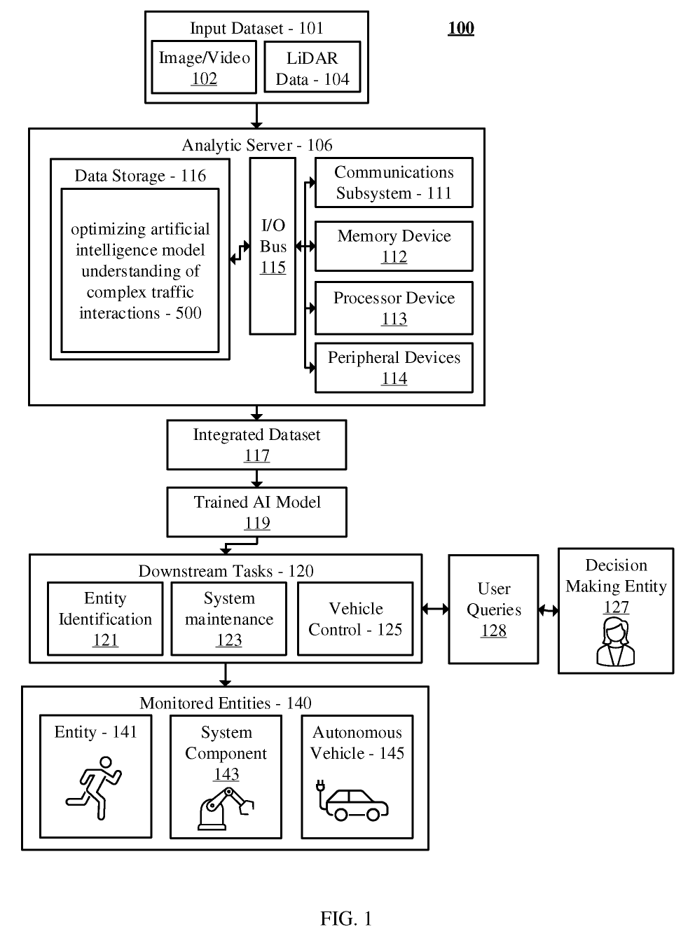

Referring now in detail to the figures in which like numerals represent the same or similar elements and initially to FIG. 1, a block diagram that shows a system for optimizing artificial intelligence model understanding of complex traffic interactions, in accordance with an embodiment of the present invention.

In an embodiment using a system 100, monitored entities 140 can include entity 141, system component 143, and autonomous vehicle 145. The monitored entities 140 can generate an input dataset 101. The input dataset 101 can include image/video 102, and light detection and ranging (LiDAR) data 104. The input dataset 101 can be transmitted to an analytic server 106 that can implement optimizing artificial intelligence model understanding of complex traffic interactions 500. The analytic server 106 can generate an integrated dataset 117 which can be utilized to obtain a trained AI model 119 that can perform downstream tasks 120.

System 100 can be utilized to perform downstream tasks 120 based on the input dataset 101 and user queries 128 from a decision-making entity 127. The downstream tasks 120 can include entity identification 121, system maintenance 123, and vehicle control 125. The analytic server 106 can generate a corrective action for the downstream tasks 120 to be sent to respective computing systems for the monitored entities 140 through a network.

In entity identification 121, the input dataset 101 (e.g., location images, scene images, entity images such as parts of the entity, etc.) related to the entity 141 can be processed by the analysis server 106 to answer user queries 128. The user queries 128 can be relevant to the entity 141 such as their attributes (e.g., position, direction of movement, color of clothing, etc.), relationship with other entities within a scene (e.g., proximity, behavior, etc.), relationship with the environment, etc. The fine-tuned VLM 107 can predict future attributes, and relationships of the entity 141.

Based on the predictions of the fine-tuned VLM 107, a corrective action can be generated by the fine-tuned VLM 107. The corrective action can include notifying the decision making entity 127 of the predictions about the entity 141 based on their input dataset 101, generating resolutions to an issue caused by the entity (e.g., the entity 141 as a disabled vehicle in a traffic scene and the resolution is the deployment of a repair technician, etc.) of the input dataset 101 to help with the decision making process of the decision making entity 127, etc.

In system maintenance 123, input dataset 101 (e.g., system logs, test cases, hardware status images, etc.) related to the system component 143 can be processed to answer user queries 128. The user queries 128 can be relevant on how to properly maintain the system component 143 based on the input dataset 101. A corrective action can be generated by the analytic server 106 which can include the answer to the user queries 128 (e.g., determine causes to bandwidth issues, etc.) to maintain the system component 143. Based on the corrective action (e.g., adding bandwidth, blocking packets from an identified internet protocol (IP) address to resolve malicious attacks, restarting hardware, etc.) the network system can be autonomously maintained.

In vehicle control 125, input dataset 101 (e.g., vehicle part status, traffic scene image, etc.) related to the autonomous vehicle 145 can be processed to answer user queries 128. The user queries 128 can be relevant to how to control the autonomous vehicle 145 given its environment based on the input dataset 101. A corrective action can be generated by the analytic server 106 which can include the answer to the user queries 128 to control the proper performance of the autonomous vehicle 145. Based on the corrective action (e.g., stopping, speeding up, changing direction, etc.) the autonomous vehicle 145 can be autonomously controlled using appropriate control devices (e.g., advanced driver assistance systems, braking device, accelerator device, cooling device, etc.) within the autonomous vehicle. In an embodiment, the autonomous vehicle 145 can be controlled in response to avoid a predicted event based on a generated trajectory such as multi-vehicle collision, accidents, detected road hazards, etc.

In another embodiment, in vehicle control 125, the autonomous vehicle 145 can be controlled to verify and test the functionality of the various components (e.g., advanced driver assistance systems, braking device, accelerator device, cooling device, etc.) of the autonomous vehicle 145 by autonomously controlling the components and generate test data that can be used to fine-tune the fine-tuned VLM 107.

Other downstream tasks and practical applications are contemplated.

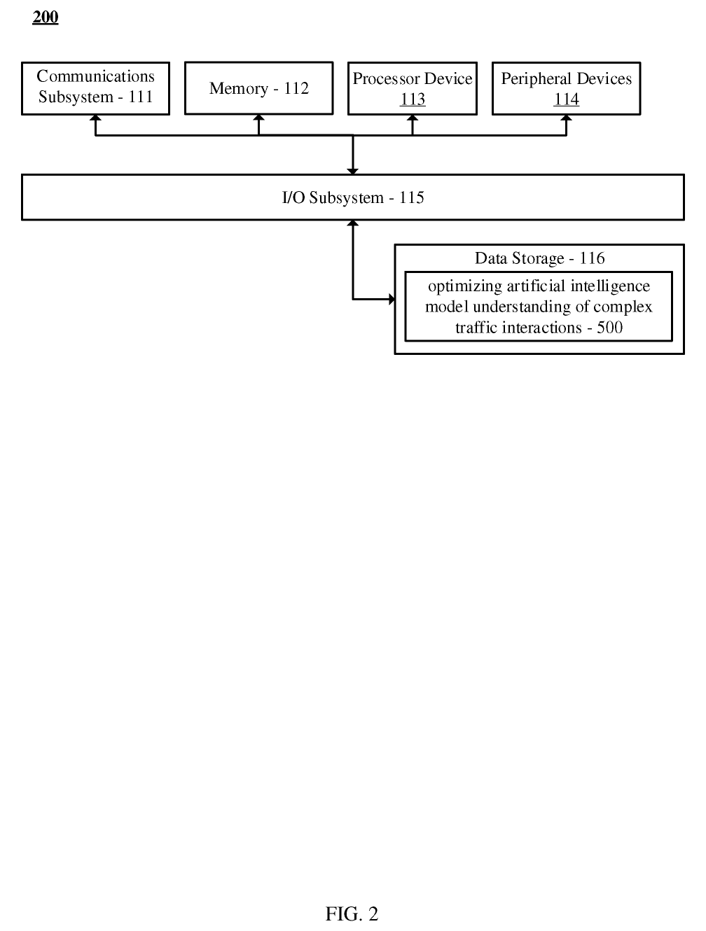

The analytic server 106 can include a processor device 113, data storage device 116, memory 112, communications subsystem 111, peripheral devices 114, and input/output (I/O) bus 115. The analytic server 106 is an implementation of a computer system. Other implementations are contemplated. The computer system is shown in more detail in FIG. 2.

Referring now to FIG. 2, a block diagram that shows a computer system for optimizing artificial intelligence model understanding of complex traffic interactions, in accordance with an embodiment of the present invention.

The computing device 200 illustratively includes the processor device 113, an input/output (I/O) subsystem 190, a memory 112, a data storage device 116, and a communications subsystem 111, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 112, or portions thereof, may be incorporated in the processor device 113 in some embodiments.

The processor device 113 may be embodied as any type of processor capable of performing the functions described herein. The processor device 113 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 112 may be embodied as any type of volatile or non-volatile memory or data storage capable of performing the functions described herein. In operation, the memory 112 may store various data and software employed during operation of the computing device 200, such as operating systems, applications, programs, libraries, and drivers. The memory 112 is communicatively coupled to the processor device 113 via the I/O subsystem 115, which may be embodied as circuitry and/or components to facilitate input/output operations with the processor device 113, the memory 112, and other components of the computing device 200. For example, the I/O subsystem 115 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 115 may form a portion of a system-on-a-chip (SOC) and be incorporated, along with the processor device 113, the memory 112, and other components of the computing device 200, on a single integrated circuit chip.

The data storage device 116 may be embodied as any type of device or devices configured for short-term or long-term storage of data such as, for example, memory devices and circuits, memory cards, hard disk drives, solid state drives, or other data storage devices. The data storage device 116 can store program code for optimizing artificial intelligence model understanding of complex traffic interactions 500. Any or all of these program code blocks may be included in a given computing system.

The communications subsystem 111 of the computing device 200 may be embodied as any network interface controller or other communication circuit, device, or collection thereof, capable of enabling communications between the computing device 200 and other remote devices over a network. The communications subsystem 111 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 114. The peripheral devices 114 may include any number of additional input/output devices, interface devices, and/or other peripheral devices. For example, in some embodiments, the peripheral devices 114 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

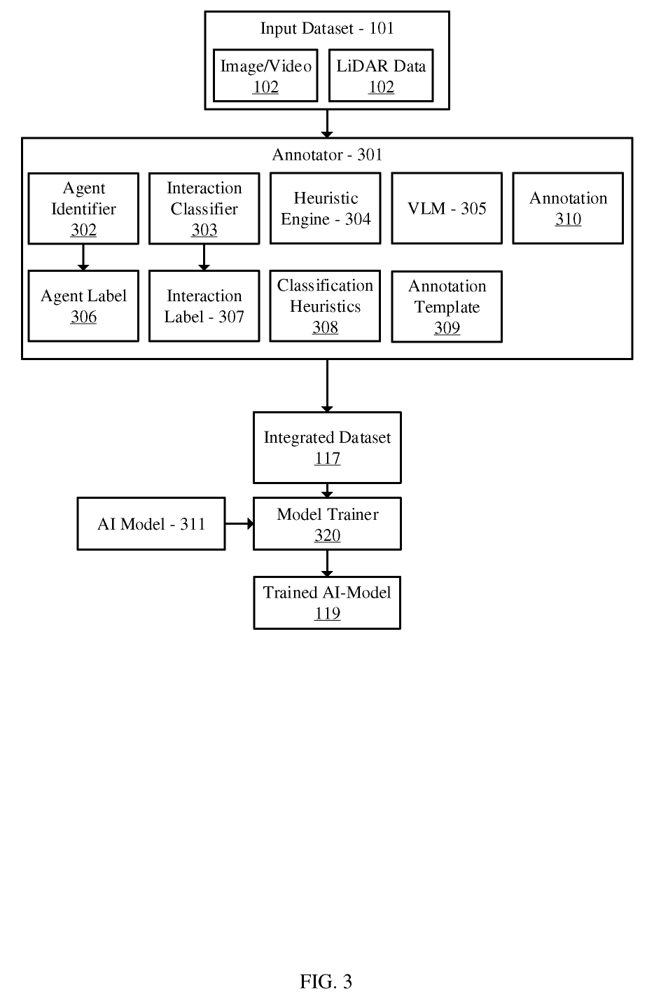

Referring now to FIG. 3, a block diagram that shows hardware and software components of a computer system for optimizing artificial intelligence model understanding of complex traffic interactions, in accordance with an embodiment of the present invention.

In an embodiment, an integrated dataset 117 can be generated by an annotator 301 from an input dataset 101. The integrated dataset 117 can be utilized by a model trainer 320 to train an AI model 311 and obtain a trained AI model 119.

The annotator 301 can include an agent identifier 302, an interaction classifier 303, and a heuristic engine 304. The agent identifier 302, interaction classifier 303, and heuristic engine 304 can utilize a visual language model (VLM) 305. The agent identifier 302 can identify entities/agents from the input dataset 101 and generate agent labels 306 for the identified entities/agents. The interaction classifier 303 can identify interactions between entities/agents and can generate interaction label 307. The heuristic engine 304 can guide the interaction classifier 303 and the agent identifier 302 with classification heuristics 308.

The annotator 301 can generate an annotation template 309 that can be utilized to annotate the input dataset 101 based on the identified agents and their interactions for each frame and generate annotations 310 based on the agent label 306 and the interaction label 307.

The integrated dataset 117 can be designed to capture nuanced agent-agent interactions within real-world driving contexts. To achieve this, a comprehensive labeling effort can be performed for annotating traffic interactions in input datasets such as Waymo Motion and NuPlan datasets. The integrated dataset 117 further includes single-agent behavioral labels obtained through heuristic annotations, providing a complete view of agent actions and interactions within diverse traffic scenarios.

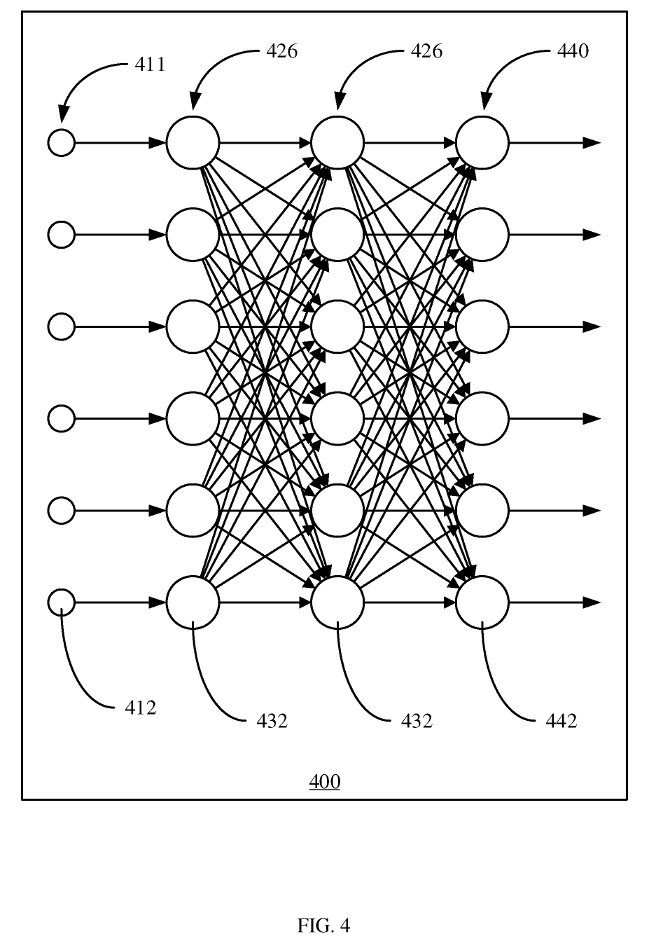

Referring now to FIG. 4, a block diagram that shows a neural network for optimizing artificial intelligence model understanding of complex traffic interactions, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example’s input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 400, such as a multilayer perceptron, can have an input layer 411 of source neurons 412, one or more computation layer(s) 426 having one or more computation neurons 432, and an output layer 440, where there is a single output neuron 442 for each possible category into which the input example could be classified. An input layer 411 can have a number of source neurons 412 equal to the number of data values 412 in the input data 411. The computation neurons 432 in the computation layer(s) 426 can also be referred to as hidden layers, because they are between the source neurons 412 and output neuron(s) 442 and are not directly observed. Each neuron 432, 442 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, … w_{n-1,} wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

Training a deep neural network can involve two phases, a forward phase where the weights of each neuron are fixed and the input propagates through the network, and a backwards phase where an error value is propagated backwards through the network and weight values are updated. The computation neurons 432 in the one or more computation (hidden) layer(s) 426 perform a nonlinear transformation on the input data 412 that generates a feature space. The classes or categories may be more easily separated in the feature space than in the original data space. In an embodiment, the neural network 400 of the VLM 305 can be trained to update hidden states configured for generating classification heuristics 308. In an embodiment, the neural network 400 of the VLM 305 can be trained to update hidden states configured for generating agent label 306 for the agent identifier 302. In an embodiment, the neural network 400 of the VLM 305 can be trained to update hidden states configured for generating interaction label 307 for the interaction classifier 303.

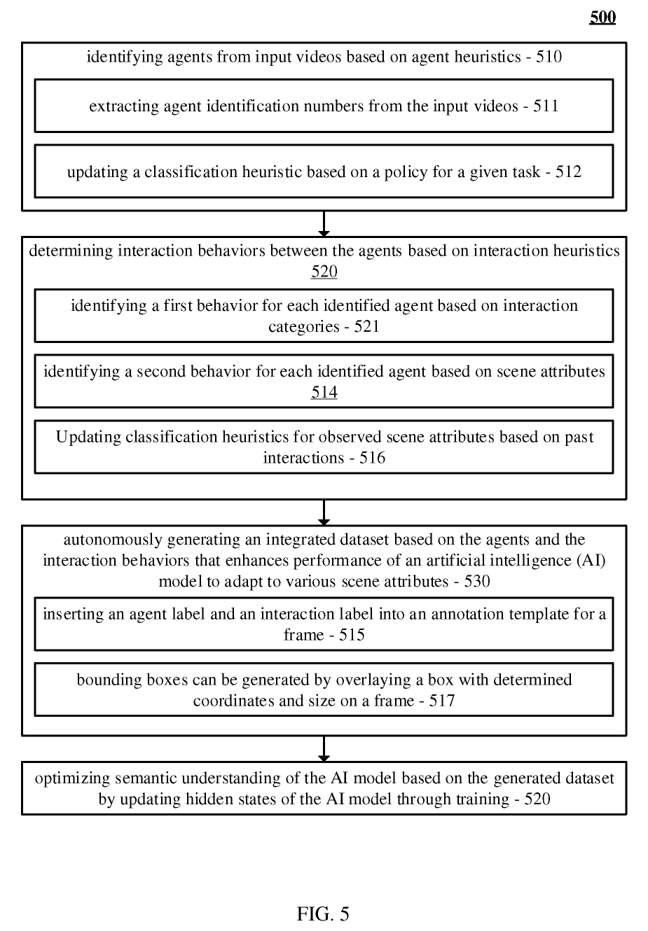

Referring now to FIG. 5, a flow diagram that shows a high-level overview of optimizing artificial intelligence model understanding of complex traffic interactions, in accordance with an embodiment of the present invention.

In an embodiment, agents can be identified from input videos based on agent heuristics. Interaction behaviors between the agents can be determined based on interaction heuristics. An integrated dataset can be autonomously generated based on the agents and the interaction behaviors that enhances performance of an artificial intelligence (AI) model to adapt to various scene attributes. Semantic understanding of the AI model can be optimized based on the generated dataset by updating hidden states of the AI model through training.

In block 510, agents can be identified from input videos based on agent heuristics.

In block 511, agent identification numbers (ID) can be extracted from the input video.

The agent identification numbers (ID) can be extracted from the input videos to have a baseline number of agents that can be identified. Additional agents can be identified by utilizing the agent identifier 302.

In block 512, a classification heuristic can be updated based on a policy for a given task.

In an embodiment, the classification heuristics 308 can be updated by the annotator 301 based on a policy for a given task. For example, for a better understanding of traffic scene, agent interactions are likely to be identified. As such, classification heuristics 308 can be updated for agent identifier 302 based on agents that potentially exhibits interactions. The interaction potential can be based on scene attributes such agent distance to each other, direction, traffic light status, etc.

In block 520, interaction behaviors between the agents can be determined based on classification heuristics.

In an embodiment, the dataset can include a wide range of interaction types, carefully annotated to provide a rich representation of traffic interactions such as:

Lane Changing: e.g., changing lanes for overtaking or merging.

Following/Stopping Behind: e.g., tailgating or stopping at a lead vehicle.

Yielding: e.g., yielding at intersections or to pedestrians.

Passing: e.g., passing through intersections.

Overtaking: e.g., high-speed overtaking.

Merging: e.g., highway on-ramp merging or zipper merging.

In block 521, a first behavior for each identified agent can be identified based on interaction categories.

The annotator 301 can identify a first behavior for each agent, from at least five interaction categories such as Lane-Changing, Yielding, Merging, or Overtaking.

In block 523, a second behavior based on the first behavior can be identified for each identified agent based on scene attributes.

For each first behavior identified, the annotator 301 can identify a second behavior which includes a more granular interaction subtype to capture interaction specifics based on scene attributes such as “Changing lane for overtaking,” “Intersection yielding,” or “Zipper merge.”

In block 525, classification heuristics for observed scene attributes can be updated based on past interactions.

The classification heuristics 308 can be updated by the annotator 301 based on observed scene attributes and past interaction. For example, for agents that include pedestrians and cyclists, observed scene attributes such as movement, direction, and distances can be utilized to update classification heuristics which can include whether the agent is static, crossing the street, walking along the road, or moving. Similarly, for vehicles, the classification heuristics 308 can include whether the vehicle is parked, off the main roads, static, moving slowly, speeding up, slowing down, moving at a constant speed, turning right, turning left, going straight, crossing an intersection, approaching an intersection, lane position, changing lanes from-to. By updating the classification heuristics 308, comprehensive behavioral modeling can be achieved in scenarios with both explicit and implicit agent interactions.

In block 530, an integrated dataset can be generated based on the agents and the interaction behaviors, and an integrated dataset that enhances the performance of artificial intelligence (AI) models to adapt to various scene attributes.

In an embodiment, an integrated dataset 117 that includes textual descriptions of semantic information and pixel-wise detection of the identified agents can be generated for various scene attributes. The various scene attributes can include road types, lighting conditions, and agent complexity (e.g., urban or suburban settings).

To generate the integrated dataset 117, for each frame, an annotation 310 can be inserted by the annotator 301 as metadata. The annotation 310 can include textual description, bounding boxes, polygons, etc. The polygons can be generated to represent interactions between the identified agents/entities.

In block 531, an annotation can be generated by inserting an agent label and an interaction label into an annotation template for a frame.

The textual description describes the semantic information in the frame which includes the identified agent and the identified interaction between the agents.

In block 533, bounding boxes can be generated by overlaying a box with determined coordinates and size on a frame.

The bounding boxes can show the pixel-wise position of the identified agents/entities in the frame with a box with position coordinates (e.g., determined x and y coordinates, length and width of the box).

In block 540, semantic understanding of the AI model can be optimized based on the generated dataset by updating hidden states of the AI model.

In an embodiment, the semantic understanding of the AI model can be optimized based on the integrated dataset 117 by updating hidden states of the AI model through training with the integrated dataset 117.

Overall, the present embodiments generate an annotated dataset that allows for in-depth study of traffic dynamics and provides a robust foundation for testing trajectory simulation models within a rich, realistic context.

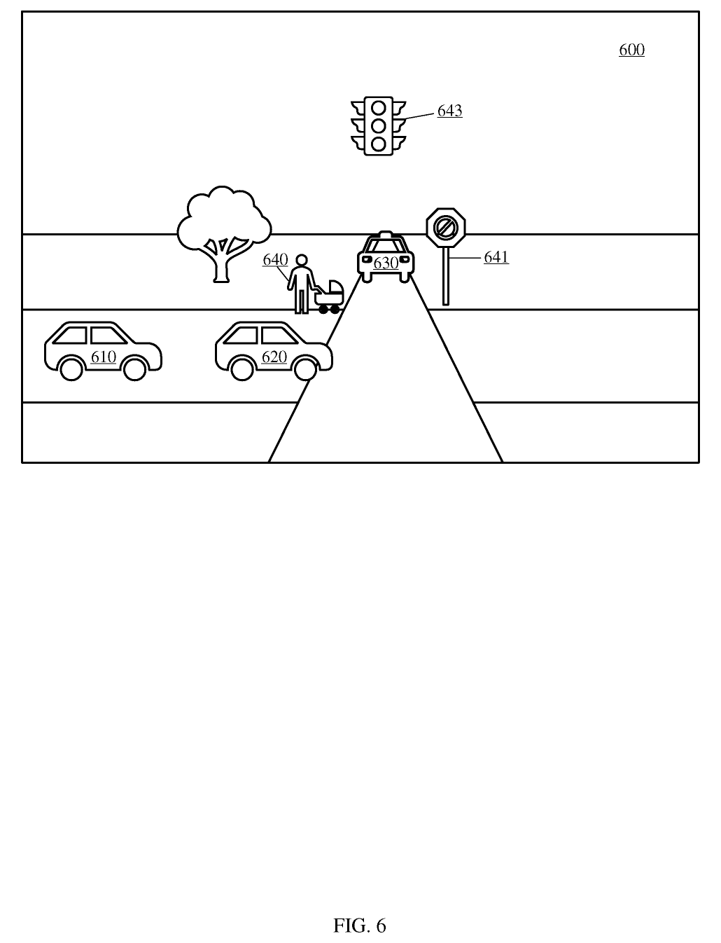

Referring now to FIG. 6, a block diagram showing a practical application of optimizing artificial intelligence model understanding of complex traffic interactions, in accordance with an embodiment of the present invention.

In an embodiment, in traffic scene 600, vehicle 610 can communicate with analytic server 106 through a network. Vehicle 610 can autonomously understand the traffic scene 600 and generate integrated dataset 117 based on the traffic scene. The integrated dataset 117 can include predictions of trajectories of the entities in the traffic scene 600. For example, the integrated dataset 117 can include the following: “vehicle (620) is in the intersection where pedestrian (640) is also crossing the intersection and taxi (630) is stopped behind one-way sign (641) as the light on (643) is red for taxi (630) and green for vehicle (620).”

In another embodiment, in traffic scene 600, vehicle 610 can simulate trajectories for the identified entities. In another embodiment, in traffic scene 600, based on the simulated trajectories of the identified entities, vehicle 610 can generate a trajectory to avoid the simulated trajectories of the identified entities and avoid collisions. In another embodiment, the vehicle 610 can be autonomously controlled based on the generated trajectory to avoid collisions.

The integrated dataset 117 can provide detailed, labeled annotations across a wide range of interaction types (e.g., lane-changing, yielding, merging, and overtaking) that capture both primary and nuanced subtypes. This level of granularity allows for a more precise representation of real-world interactions, going beyond typical label categories in existing datasets.

By integrating annotations from known datasets (e.g., Waymo and NuPlan), the integrated dataset captures a broader range of environments, agent types, and driving conditions. This diverse data composition enhances the generalizability of autonomous models trained on the dataset, allowing them to adapt to different road types, lighting conditions, and urban or suburban settings.

In addition to interaction labels, the integrated dataset includes heuristic annotations for single-agent behaviors (e.g., lane changes, stopping, intersection crossing) that enable more complete behavioral modeling, including implicit actions that set up or respond to interactions. This complements the interaction labels by capturing individual agent intentions in a context that informs future interactions.

The integrated dataset provides not only high-level interaction categories but also specific subtypes, such as “Changing lane for overtaking” or “Zipper merge,” which add depth to the dataset and support more nuanced predictive modeling of agent behavior. These fine-grained categories enable algorithms to better differentiate between similar interactions and make more context-aware predictions.

Each scene of the integrated dataset can include high definition image map data, LIDAR, and images or image embeddings for selected frames, providing a rich, multimodal data foundation that supports advanced trajectory prediction and scene understanding. This enables autonomous systems to leverage various sensory inputs to interpret interactions, improving robustness in complex driving environments.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method, comprising:
identifying agents from input videos based on agent heuristics;
determining interaction behaviors between the agents based on interaction heuristics;
autonomously generating an integrated dataset based on the agents and the interaction behaviors that enhances performance of an artificial intelligence (AI) model to adapt to various scene attributes; and
optimizing semantic understanding of the AI model based on the generated dataset by updating hidden states of the AI model through training.

2. The method of claim 1, wherein identifying the agents further comprises extracting agent identification numbers from the input videos.

3. The method of claim 1, wherein identifying the agents further comprises updating a classification heuristic based on a policy for a given task.

4. The method of claim 1, wherein determining the interaction behaviors further comprises identifying a first behavior for each identified agent based on interaction categories.

5. The method of claim 1, wherein determining the interaction behaviors further comprises identifying a second behavior for each identified agent based on scene attributes.

6. The method of claim 1, wherein autonomously generating the integrated dataset further comprises inserting an agent label and an interaction label into an annotation template for a frame.

7. The method of claim 1, further comprising controlling an autonomous vehicle to avoid road hazards detected with the AI model.

8. A system, comprising:
a memory device;
one or more processor devices operatively coupled with the memory device to perform operations including:
identifying agents from input videos based on agent heuristics;
determining interaction behaviors between the agents based on interaction heuristics;
autonomously generating an integrated dataset based on the agents and the interaction behaviors that enhances performance of an artificial intelligence (AI) model to adapt to various scene attributes; and
optimizing semantic understanding of the AI model based on the generated dataset by updating hidden states of the AI model through training.

9. The system of claim 8, wherein identifying the agents further comprises extracting agent identification numbers from the input videos.

10. The system of claim 8, wherein identifying the agents further comprises updating a classification heuristic based on a policy for a given task.

11. The system of claim 8, wherein determining the interaction behaviors further comprises identifying a first behavior for each identified agent based on interaction categories.

12. The system of claim 8, wherein determining the interaction behaviors further comprises identifying a second behavior for each identified agent based on scene attributes.

13. The system of claim 8, wherein autonomously generating the integrated dataset further comprises inserting an agent label and an interaction label into an annotation template for a frame.

14. The system of claim 8, further comprising controlling an autonomous vehicle to avoid road hazards detected with the AI model.

15. A non-transitory computer program product comprising a computer-readable storage medium including a program code, wherein the program code when executed on a computer causes the computer to perform operations including:
identifying agents from input videos based on agent heuristics;
determining interaction behaviors between the agents based on interaction heuristics;
autonomously generating an integrated dataset based on the agents and the interaction behaviors that enhances performance of an artificial intelligence (AI) model to adapt to various scene attributes; and
optimizing semantic understanding of the AI model based on the generated dataset by updating hidden states of the AI model through training.

16. The non-transitory computer program product of claim 15, wherein identifying the agents further comprises extracting agent identification numbers from the input videos.

17. The non-transitory computer program product of claim 15, wherein identifying the agents further comprises updating a classification heuristic based on a policy for a given task.

18. The non-transitory computer program product of claim 15, wherein determining the interaction behaviors further comprises identifying a first behavior for each identified agent based on interaction categories.

19. The non-transitory computer program product of claim 15, wherein determining the interaction behaviors further comprises identifying a second behavior for each identified agent based on scene attributes.

20. The non-transitory computer program product of claim 15, further comprising controlling an autonomous vehicle to avoid road hazards detected with the AI model.
